(19) United States
(12) Patent Application Publication
(10) Pub. No.: US 2004/0114809 A1
(43) Pub. Date: Jun. 17, 2004

(54) Image compression method

(75) Inventor: Yong-Nam Kim, Suwon-shi (JP)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/701,648

(22) Filed: Nov. 5, 2003

(30) Foreign Application Priority Data
Dec. 11, 2002 (KR) 2002-78669

(51) Int. Cl. G06K 9/36

(52) U.S. Cl. 382/232

(57) ABSTRACT

Disclosed herein is a method for compressing an image using a permissible-error (PE) encoding method and a dynamic link-size encoding method. An image compression efficiency can be increased by selectively applying the permissible-error encoding method and the dynamic link-size encoding method to a zero loss compression method, for example, a Lempel-Ziv compression method.

### PRIORITY

This application claims priority to an application entitled “IMAGE COMPRESSION METHOD”, filed in the Korean Industrial Property Office on Dec. 11, 2002 and assigned Serial No. 2002-78669, the contents of which are incorporated herein by reference.

### BACKGROUND OF THE INVENTION

1. Field of the Invention

The present invention relates to an image compression method, and more particularly to a method for compressing an image using a zero loss compression algorithm.

2. Description of the Related Art

Generally, in the process of transmitting an image to a destination device, a compression method is applied to the image to be transmitted, in order to minimize a loss of image data and a degradation in picture quality so as to transmit image data of high quality. Many image compression methods have been proposed and used according to each device which receives an image.

Conventional compression methods can be roughly classified into several types, a zero loss compression method, a low loss compression method and a hybrid compression method. Firstly, the zero loss compression method is appropriate for use in items whose data must be subject to no loss, such as texts, facsimiles and programs. In this regard, the zero loss compression method is used in only the case where, when compressed data is decoded, the decoded data must be the same as the data prior to compression. Secondly, the low loss compression method is used in the case where, even though a portion of high-volume data, such as an image, is lost, it is reproduced in substantially the same form. Lastly, the hybrid compression method employs a proper combination of the zero loss compression method and low loss compression method to raise a compression ratio.

The zero loss compression method can be roughly classified into a repetitive sequence suppression method and a statistical encoding method. These compression methods are adapted to encode desired data lengths using data repetition, and may be, for example, a run-length encoding method, a pattern substitution method, a Huffman encoding method, a Lempel-Ziv encoding method, etc.

The low loss compression method can be roughly classified into a transform method, a quantization method, a prediction method and an interpolation method. These compression methods may be, for example, a discrete Fourier transform method, a wavelet transform method, etc. The zero loss compression method typically exhibits compression ratios of 20 to 50% according to objects to be compressed. The low loss compression method can compress data in a significantly higher compression ratio depending on the degree of data loss.

The hybrid compression method is implemented by utilizing both the zero loss compression method and low loss compression method, and is currently used in the form of various image standards, which may be, for example, JPEG (Joint Photographic Experts Group), H.261, MPEG (Motion Picture Experts Group), etc.

A description will hereinafter be given of the run-length encoding method which is most often used among the conventional zero loss compression methods and the Lempel-Ziv compression method which is known to have the best performance among those zero loss compression methods.

The run-length encoding (referred to hereinafter as RLE) method is a compression method which is advantageous when a large amount of duplicated data is present in data to be compressed. This RLE compression method is the simplest among the compression methods, but is considered to have a lower compression efficiency. The fundamental principle of the RLE compression method is to use a technique for transcribing duplicated data and the number of duplications of the duplicated data. In this connection, the RLE compression method cannot obtain high efficiency with respect to discontinuous data because it is used on the basis of the condition that data must be duplicated. For this reason, the RLE compression method is mainly used in compressing a graphic image in which codes are mostly consecutive. For example, for a text string “TFBBBBBBBBBBBBBCIT”, ‘B’ is repeated 13 times between “TF” and “CIT”. In this case, the RLE compression method can code the text string into, for example, “TFB@13CIT” by using a special character ‘@’ for repeated “Bs”. This coded result can be decoded on the basis of the meaning that ‘B’ is repeated 13 times.

The Lempel-Ziv compression method is a statistical encoding method which can obtain a higher compression ratio by recognizing patterns of codes and using positions and lengths of the recognized patterns, instead of repeating the same codes. In this regard, the Lempel-Ziv compression method can compress a larger number of cases compared with the RLE compression method, because it includes cases of the same patterns as well as cases of the same codes, but does not exhibit a great effect with respect to a complex image. For example, assume that a given text string is “the_other_one_is_the_oldest”.

If repeated patterns are expressed as [position, length], then the above text string can be encoded as follows:

“the_o[1,3]r[4,2]n[3,2]is_{—}[1,5]ldest”

In the above example, the Lempel-Ziv compression method does not compress the case of one character and expresses only the case of two or more characters as their respective positions and lengths. Because this Lempel-Ziv compression method allows the decoding of next data using previously decoded data, it is not so complicated and can be easily utilized for image compression.

However, the above RLE compression method and Lempel-Ziv compression method exhibit a great compression ratio difference according to objects to be compressed, and have an average compression ratio of about 50%. This compression ratio is considered to be rather poor as compared with that of the low loss compression method which compresses data in a ratio of several tens to one.

These existing compression methods are selected and used appropriately to respective devices. For example, “jpeg” and “gif” which are utilized as image formats on personal computers (PCs) may be standards using such compression methods. These complex image formats are difficult to use in PCs with abundant resources and other embedded systems, if a decoding speed and memory efficiency are considered.

Wireless terminal systems, which are a representative example of the embedded systems, have required more colorful images as display modules have gradually become more sophisticated and changed into color liquid crystal displays (LCDs) with high resolution. Also, an image data compression method is essentially required to store a large amount of image data in a limited memory space.

However, in the case where a device employs an existing image compression method with an excellent compression ratio, it can have a good compression ratio, but must be equipped with a separate central processing unit (CPU) due to load occurring when a compressed image is decoded. Provided that the zero loss compression method is directly applied to the device for the purpose of avoiding such a problem, it can reduce the amount of load when a compressed image is decoded, but has different compression ratios according to the types of images. It is difficult to expect the zero loss compression method to obtain good results, because its average compression ratio is not more than about 50%. The wireless terminal systems cannot employ such a compression method with a poor compression ratio, since they require a proper decoding speed although they are limited in memory use.

For example, the wireless terminal systems have difficulty in using a hybrid compression method, such as “jpeg” currently defined as a standard, because of its decoding time. That is, in the wireless terminal systems, a decoding operation must be performed within 100 or 200 ms for display of at least 6 to 7 frames per one second. However, in the case where the hybrid compression method is used, a period of time approximating one second is required in performing the decoding operation for display of one frame. For this reason, the hybrid compression method is hard to apply to the wireless terminal systems. Of course, the decoding operation may be performed at a higher speed by applying to a device a display-dedicated CPU or a CPU of a faster clock. However, most embedded systems, such as the wireless terminal systems, employ a single CPU, so there is a need for a better compression method under such a limited condition.

Where the RLE compression method or Lempel-Ziv compression method is used for image compression in the wireless terminal systems, it can obtain a compression effect to a certain extent, but cannot compress high-grade images or complex images. Namely, the RLE compression method or Lempel-Ziv compression method can obtain the compression effect with respect to only fragmented and simple images. In practice, if the RLE compression method and Lempel-Ziv compression method are applied to the wireless terminal systems, then compression ratios can be obtained, respectively, on the order of 75 to 85% in the RLE compression method and on the order of 70 to 80% in the Lempel-Ziv compression method, on the assumption that the original image, not compressed, is 100%. As seen from these results, the Lempel-Ziv compression method shows a slightly superior result over the RLE compression method, but it is difficult to expect the Lempel-Ziv compression method to obtain a great image compression effect.

In practice, the zero loss compression method can obtain a great compression effect with respect to black-and-white bitmap or simple images. However, even in the case of visually identical pictures, RGB codes of bitmaps expressing them often have quite different values or very similar values due to the upgrading of images and various image processing effects, thereby making it hard for the zero loss compression method to obtain a great compression effect. Where the Lempel-Ziv compression method is used to compress these images, it cannot detect many of the cases of the repeated same patterns of the images due to a very small difference, so the images cannot be compressed.

### SUMMARY OF THE INVENTION

Therefore, the present invention has been made in view of the above problems, and it is an object of the present invention to provide an image compression method which is capable of obtaining the optimum compression ratio for rapid image decoding and effective memory use in a wireless terminal system.

It is another object of the present invention to provide an image compression method which is capable of increasing an image compression efficiency and minimizing a loss rate when a compressed image is decoded.

In accordance with one aspect of the present invention, the above and other objects can be accomplished by the provision of an image compression method for increasing a data rate and decoding performance of an image to be transmitted, comprising the steps of a) determining whether respective codes corresponding-to the image are repeated, encoding repeated codes of the corresponding codes into linked data indicative of a start position of the-repeated codes and the number thereof and encoding non-repeated codes of the corresponding codes into unlinked data indicative of the non-repeated codes; and b) setting a linked data size indicative of information regarding an entire size of the linked data, consecutively arranging the linked data, arranging the linked data size upstream of the consecutively arranged linked data and arranging the unlinked data downstream of the consecutively arranged linked data, thereby encoding the image into encoded data.

In accordance with another aspect of the present invention, there is provided an image compression method for increasing a data rate and decoding performance of an image to be transmitted, comprising the steps of a) determining whether respective codes corresponding to the image are repeated, encoding repeated codes of the corresponding codes into linked data indicative of a start position of the repeated codes and the number thereof and encoding non-repeated codes of the corresponding codes into unlinked data indicative of the non-repeated codes; and b) setting a permissible error with respect to each of the linked data and encoding the linked data within the range of the set permissible error.

Preferably, the permissible error may be variably set and the image may be increased in its compression efficiency as the range of the permissible error becomes wider.

In accordance with a further aspect of the present invention, there is provided an image compression method for increasing a data rate and decoding performance of an image to be transmitted, comprising the steps of a) initializing 0 s a position of a current pixel of the image to be encoded and a position of a previous pixel to be compared with the current pixel to find repeated patterns with respect to the current pixel, respectively; b) comparing the current pixel position with the previous pixel position to determine whether the current pixel position is less than the previous pixel position; c) obtaining differences between code values from the current pixel position to a certain pixel position and code values from the previous pixel position to just before the current pixel position if the current pixel position is determined to be less than the previous pixel position; d) selecting one of the differences existing within the range of a set permissible error as a permissible value and determining whether the permissible value is repeated; and e), if the permissible value is determined to be repeated, transforming the repeated permissible values into linked data including a start position of the repeated permissible values and the number thereof and, if the permissible value is determined not to be repeated, maintaining the permissible value, thereby encoding the image into encoded data.

In accordance with another aspect of the present invention, there is provided an image compression method for increasing a data rate and decoding performance of an image to be transmitted, comprising the steps of a) initializing to 0 s a position of a current pixel of the image to be encoded and a position of a previous pixel to be compared with the current pixel to find repeated patterns with respect to the current pixel, respectively; b) comparing the current pixel position with the previous pixel position to determine whether the current pixel position is less than the previous pixel position; c) determining whether code values from the current pixel position to a certain pixel position and code values from the previous pixel position to just before the current pixel position are repeated, if the current pixel position is determined to be less than the previous pixel position; d) transforming repeated code values of the code values into linked data including a start position of the repeated code values and the number thereof and maintaining non-repeated code values ones of the code values as unlinked data; e) setting information regarding an entire size of the linked data, consecutively arranging the linked data and arranging the entire size information of the linked data upstream of the consecutively arranged linked data; and f) arranging the unlinked data downstream of the consecutively arranged linked data.

Preferably, the entire size of the linked data may be one of 4 bytes and 6 bytes.

In accordance with yet another aspect of the present invention, there is provided an image compression method for increasing a data rate and decoding performance of an image to be transmitted, comprising the steps of a) initializing to 0 s a position of a current pixel of the image to be encoded and a position of a previous pixel to be compared with the current pixel to find repeated patterns with respect to the current pixel, respectively; b) comparing the current pixel position with the previous pixel position to determine whether the current pixel position is less than the previous pixel position; c) obtaining differences between code values from the current pixel position to a certain pixel position and code values from the previous pixel position to just before the current pixel position if the current pixel position is determined to be less than the previous pixel position; d) selecting one of the differences existing within the range of a set permissible error as a permissible value and determining whether the permissible value is repeated; e), if the permissible value is determined to be repeated, transforming the repeated permissible values into linked data including a start position of the repeated permissible values and the number thereof and, if the permissible value is determined not to be repeated, maintaining the permissible value, thereby encoding the image into encoded data; and f) setting information regarding an entire size of the linked data, consecutively arranging the linked data, arranging the entire size information of the linked data upstream of the consecutively arranged linked data and arranging unlinked data downstream of the consecutively arranged linked data.

Preferably, step e) may include the step of performing a permissible-error encoding operation, and step f) may include the step of performing a dynamic link-size encoding operation. The permissible error may be variably set and the image may be increased in its compression efficiency as the range of the permissible error becomes wider. The entire size of the linked data may be one of 4 bytes and 6 bytes.

In a feature of the present invention, a permissible-error (PE) encoding method and a dynamic link-size encoding method are selectively applied to a zero loss compression method to compress an image. Therefore, an image compression efficiency can be raised. The zero loss compression method may be, for example, a Lempel-Ziv compression method. Moreover, the permissible-error encoding-compression method is applied to a target image to encode it into code values with small differences. This can obtain an excellent compression effect over the existing image compression based on only the Lempel-Ziv compression method. Furthermore, the dynamic link-size encoding method is additionally applied to an image encoded according to the Lempel-Ziv compression method and, in turn, the permissible-error encoding method. This has the effect of compressing the image three times, so as to obtain a higher compression efficiency.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the configuration of an RGB code expressing one pixel in a 16-bit bitmap;

FIG. 2 is a view showing an example of encoded RGB code data compressed according to a Lempel-Ziv compression method;

FIG. 3 is a flow chart illustrating the Lempel-Ziv compression method among zero loss compression methods;

FIG. 4 is a flow chart illustrating a linked data registration step in FIG. 3 in detail;

FIG. 5 is a view showing a decoded state of an image compressed according to the Lempel-Ziv compression method of FIG. 3;

FIG. 6 is a view illustrating the substitution of a condition of step S123 in FIG. 4 with a condition including preset permissible error values, which is applied to an image compression method in accordance with a preferred embodiment of the present invention;

FIG. 7 is a view showing encoded data changed by applying a dynamic link-size encoding method to the Lempel-Ziv compression method;

FIG. 8 is a flow chart illustrating a method for compressing an image by applying the dynamic link-size encoding method to the Lempel-Ziv compression method in accordance with an alternative embodiment of the present invention;

FIG. 9 is a flow chart illustrating a procedure of decoding encoded data compressed according to the image compression method of FIG. 8; and

FIG. 10 is a view showing compression ratios of images compressed according to the first and second embodiments of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description made in conjunction with preferred embodiments of the present invention, a variety of specific elements are shown. The description of such elements has been made only for a better understanding of the present invention. Those skilled in the art will appreciate that the present invention can be implemented without using the above-mentioned specific elements. In the following description of the present invention, a detailed description of known functions and configurations incorporated herein will be omitted when it may obscure the subject matter of the present invention.

The fundamental principle of the present invention is to use an existing Lempel-Ziv compression method as a bitmap image compression algorithm and apply a permissible-error encoding method and a dynamic link-size encoding method, presented according to embodiments of the invention, to the Lempel-Ziv compression method.

Before the present invention is described, a description will be given of the Lempel-Ziv compression method. There are various methods representing images and one is where the RGB code values express bitmaps. Various types of bitmaps can be provided according to the number of color bits of images. For example, R-G-B (Red-Green-Blue) are each composed of 8 bits for a 24-bit bitmap, and R-G-B are composed of 5 bits-6 bits-5 bits for a 16-bit bitmap, respectively. That is, different types of bitmaps are provided according to associated devices. Two bytes are required for the 16-bit bitmap to express one pixel. As a result, in expressing an image of a “128×160” size in the 16-bit bitmap, a memory of 40 Kbytes is required as in the below equation 1.

128×160×2=40960 [bytes]=40 [Kbytes] [Equation 1]

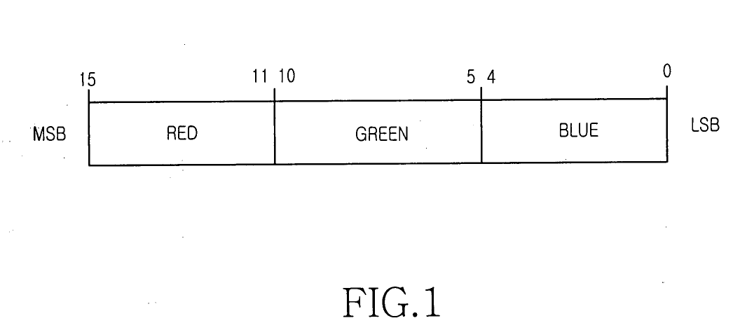

FIG. 1 shows the configuration of an RGB code expressing one pixel in the 16-bit bitmap. As shown in this drawing, for the RGB code of one pixel, R-G-B are composed of 5 bits-6 bits-5 bits, respectively. As a result, red and blue values can be any values within the range of 0 to 31 and a green value can be any value within the range of 0 to 63.

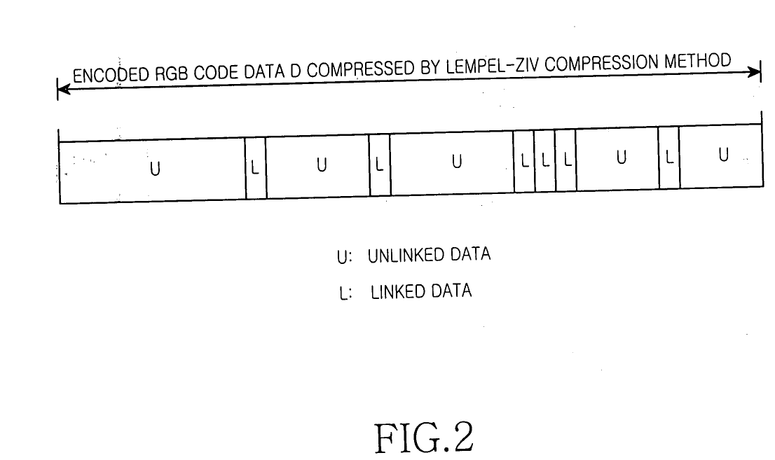

On the other hand, the Lempel-Ziv compression method is adapted to encode repeated patterns and output the encoded result as one link. Here, the link includes the start position and number of repeated patterns. In the present; invention, an encoding operation is performed by conducting a compression operation on an RGB code basis by the Lempel-Ziv compression method, comparing RGB code values of consecutive pixels and, when RGB code values of the same patterns appear, outputting the same patterns as one link. In the case where it is determined from the pattern comparison that there are no identical patterns, raw data is included in the encoded data in its original format. Compression effects on portions of the encoded data, composed of links, will be different according to pattern lengths. FIG. 2 shows an example of encoded RGB code data compressed according to the Lempel-Ziv compression method. As shown in this drawing, encoded data D compressed according to the Lempel-Ziv compression method includes linked data L for duplicated patterns and unlinked data U for non-duplicated patterns.

In the Lempel-Ziv compression method, if data of repeated patterns is found, then it is transformed into linked data and included in the encoded data. At this time, the unit linked data has a format including “Link Identifier”, “Start Offset” and “Matched Number”. The “Link Identifier” functions as an identifier for distinguishing two subsequent data as linked data from other data in a decoding operation. The “Start Offset” is a value indicative of a number of streams of consecutive pixels, identical to a current link. The “Matched Number” is a value indicative of the number of identical streams beginning with a current offset.

It should be noted here that the “Link Identifier” must be a value different from all RGB code values of an image to be currently encoded. The reason is that, if the same RGB code as any one of the RGB codes of the image is used as the “Link Identifier”, a determination cannot be made in the decoding operation as to whether it is an actual RGB code or it is a value used as the “Identifier”. For this reason, in the process of encoding the 16-bit bitmap, the entire image is searched for an unused RGB code value and the unused RGB code value is used as the “Link Identifier”. For a bitmap of a smaller number of bits, n bits, the first bit can be recognized as the “Link identifier”. The “Start Offset” is an item indicative of a number of a pixel at which identical patterns start when the entire image is arranged in the form of RGB codes in pixel units. The “Matched Number” is a value indicative of the number of identical patterns beginning with the “Start Offset”.

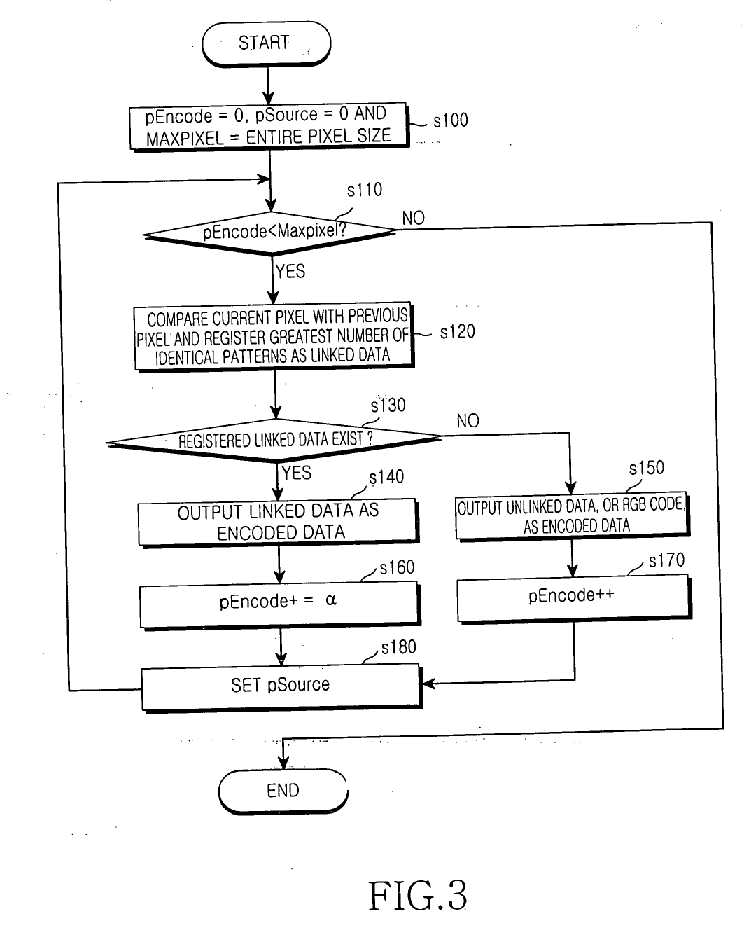

FIG. 3 is a flow chart illustrating the Lempel-Ziv compression method among zero loss compression methods. First, variables necessary for compression of a target image are initialized (S100). Here, the variables are “MaxPixel”, “pEncode” and “pSource”. The “MaxPixel” is a value representing the number of all pixels to be encoded, the “pencode” is a value representing the position of a current pixel to be encoded, and the “pSource” is a value representing the position of a previous pixel to be compared with the current pixel to find repeated patterns. At the initial step S100, the “MaxPixel” is initialized to the total number of (vertical×horizontal) pixels of a current image, and the “pEncode” and “pSource” are each initialized to 0 s,.

If the variables are initialized, then the “pEncode” is compared with the “MaxPixel” (S110). If the “pEncode” is determined not to be less than the “MaxPixel”, then the encoding operation is ended. However, if the “pEncode” is determined to be less than the “MaxPixel”, then the current pixel is compared with the previous pixel to find pixel streams identical to a pixel stream from the pEncode to pEncode+α from among pixels at the pSource to pSource-1. Then, the greatest identical patterns among the numbers of identical patterns, or repeated patterns, for each pixel is registered as linked data (S120).

Accordingly, a determination is made from the presence/absence of repeated patterns as to whether registered linked data exists (S130). If registered linked data is determined to exist, then the linked data is outputted as encoded data (S140). Alternatively, if registered linked data is determined not to exist, then an RGB code at the pEncode is outputted as encoded data (S150). As a result, the finally obtained data has a format as shown in FIG. 2.

If the linked data is outputted as the encoded data at the above step S140, then the pEncode is incremented by the size of the linked data (S160). In FIG. 3, the size of the linked data is shown to be set to α. If the RGB code,at the pEncode is outputted as the encoded data at the above step S150, then the pEncode is incremented by one pixel (S170). After step S160 or S170 is performed, the position pSource of a previous pixel to be compared is set (S180). The above steps S110 to S180 are repeatedly performed on the basis of the set pSource.

Provided that the pSource is set to 0 at step S180, the optimum linked data will be found, whereas the encoding time will become longer, so the compression efficiency will be raised. Provided that the encoded linked data has a certain window size depending on the pEncode, the encoding time will be shortened, but the linked data will not be optimal, thereby reducing the compression effect.

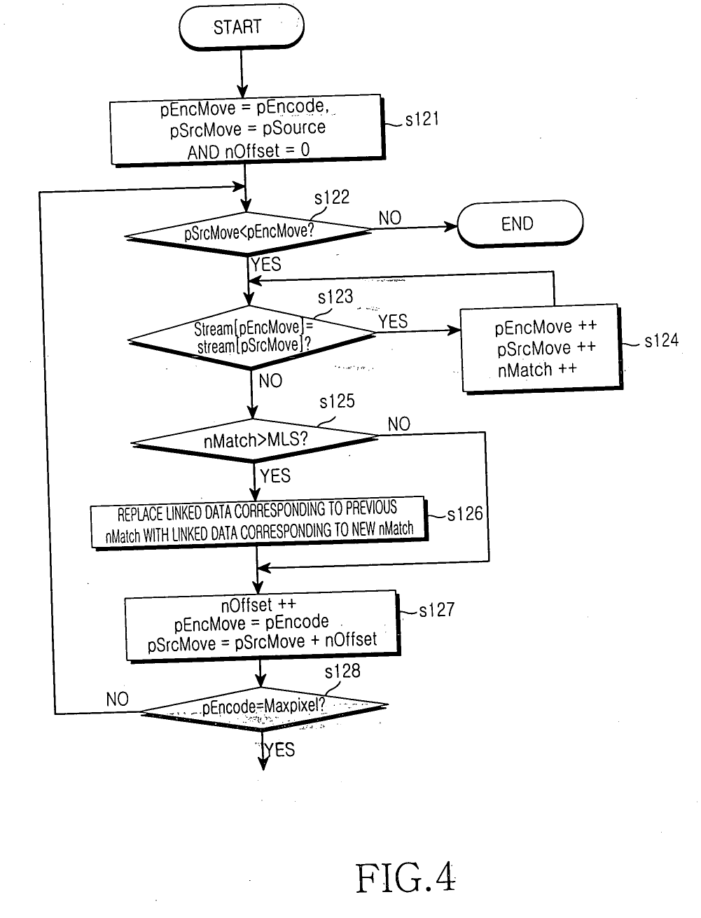

FIG. 4 is a flow chart illustrating the linked data registration step S120 in FIG. 3 in detail. First, if the pEncode is determined to be less than the pSource, then pEncMove, which is a position to be compared and increased on the basis of the pEncode, is initialized to the pEncode, pSrcMove, which is a position to be compared and increased on the basis of the pSource, is initialized to the pSource, and nOffset, which is an offset of the pSource where the comparison is to start, is initialized to 0 (S121).

After the pEncMove, pSrcMove and nOffset are initialized, a determination is made as to whether the pEncMove is greater than the pSrcMove (S122). If the pEncMove is determined not to be greater than the pSrcMove, then the image compression operation is ended. However, in the case where the pEncMove is determined to be greater than the pSrcMove, a comparison is made between Stream[pEncMove], which is a stream of RGB codes arranged in the order of pixels of a current image, and Stream[pSrcMove], which is a stream of RGB codes arranged in the order of pixels of a previous image (S123). If the Stream[pEncMove] and Stream[pSrcMove] are determined to be identical, then the pEncMove, pSrcMove and nMatch, which is a value representing the number of identical streams, are incremented by 1s, respectively (S124).

If the Stream[pEncMove] and-Stream[pSrcMove] are determined not to be identical, then a determination is made as to whether the nMatch is greater than a minimum link size (MLS) set for linked data determination (S125). Note that each linked data has a size of about three pixels. In this regard, provided that data of three or less pixels is expressed as linked data, it will not be compressed and, rather, results in an increase in the size of encoded data. For this reason, only when the size of compared data is greater than a predetermined value, the nMatch is appended to linked data. Namely, if the nMatch is determined to be greater than the minimum link size, then it is appended to the linked data.

If a new nMatch greater than the existing link size is obtained in the process of window mapping for comparison between the pEncode and the pSource, the linked data corresponding to the previous nMatch is replaced with linked data corresponding to the new nMatch (S126). That is, linked data corresponding to nMatch indicative of a largest number of identical data is selected from among several extracted linked data.

The nOffset, which is an offset of the pSource where the comparison is to start, is incremented by 1, the pEncMove is set to the pEncode, and the pSrcMove is set to a value of pSrcMove+nOffset (S127). If the nOffset, pEncMove and pSrcMove are newly set, then a determination is made as to whether the pEncode is equal to the MaxPixel representing the number of all pixels to be encoded (S128).

If the pEncode is determined to be equal to the MaxPixel, then step S130 is carried out with respect to the linked data obtained at step S126. However, if the pEncode is determined not to be equal to the MaxPixel, then steps S122 to S127 are performed.

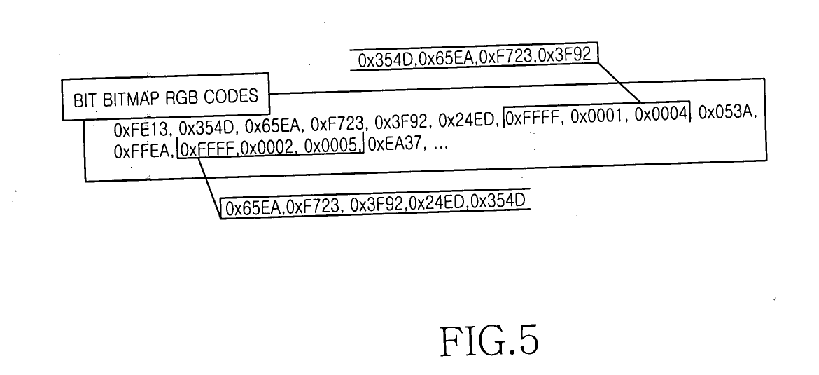

FIG. 5 shows a decoded state of an image compressed according to the Lempel-Ziv compression method of FIG. 3. As shown in this drawing, a decoding operation is performed by analyzing registered linked data encoded according to the Lempel-Ziv compression method and copying data corresponding to the analysis result. Unlinked data is copied until “Link Identifier” is found while the positions of encoded pixels are increased one by one. The unlinked data need not be subjected to other processes because the data itself is RGB code values. When the “Link Identifier” is found, “Start Offset” and “Matched Number” are parsed and data corresponding to the parsed results is copied from previous pixels. This decoding operation can reduce the amount of load on a device CPU by an amount corresponding to the direct use of raw data. As a result, the decoding operation can be smoothly performed even in case of a fast screen shift.

In FIG. 5, the Link Identifier, “0×FFFF”, and decoded values of respective links are shown with respect to compressed RGB codes of consecutive pixels.

Now, a description will be given of a method for compressing an image by applying a permissible-error encoding method to the above-stated Lempel-Ziv compression method in accordance with a preferred embodiment of the present invention.

In a bitmap of an image, each pixel is composed of an RGB code, as shown in FIG. 1, and the color of the image is determined depending on R-G-B values. Although the image color varies according to an indexing scheme for creating color palette of the image, the R-G-B values do not exhibit great differences with their respective neighboring color values on the assumption that a basic palette is used. That is, there is no great visual difference between when the R value of a certain pixel is 25 and when it is 26 or 24. This is also similarly true of the G and B values.

Using the above principle, the present embodiment is adapted to compress an image by applying the permissible-error encoding method to the existing Lempel-Ziv compression method. Although the original Lempel-Ziv compression method is a zero loss compression method, a greater compression effect can be obtained by performing the encoding operation while inducing errors in a direction in which the compression is well done.

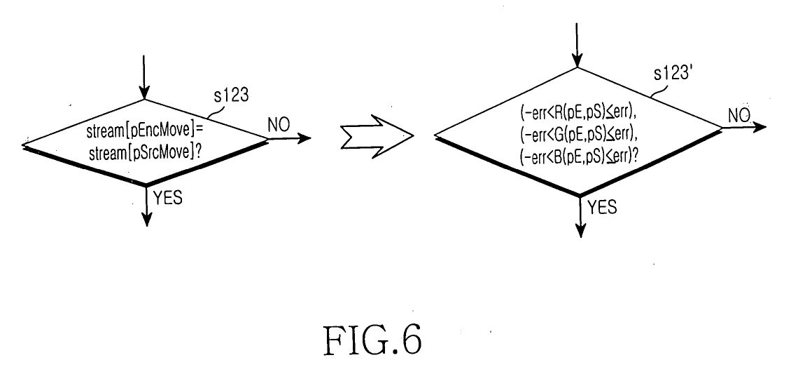

At step S123 in FIG. 4, a comparison is made between an RGB code value of a current pixel and an RGB code value of a previous pixel to determine whether the two code values are equal. The comparison is continued if the two code values are equal, and otherwise stopped, 5 resulting in a considerably restricted condition. Provided that this comparison condition has a permissible error margin with respect to data to be compared, as described above, a larger number of pixels will be passed through the comparison condition, so a larger amount of linked data will be generated, resulting in an increase in the compression ratio. Accordingly, the compression ratio can be increased by substituting the condition of step S123 in FIG. 4 with a condition of step S123′ as shown in FIG. 6. In FIG. 6, the more the permissible error amount, the higher the compression ratio, although the original image suffers a greater amount of loss.

Among variables shown in FIG. 6, “err” is a permissible error value between two pixels, “R(pE,pS)” is a difference between red code values of pE pixel and pS pixel, and “G(pE,pS)” is a difference between green code values of the pE pixel and pS pixel. Also, “B(pE,pS)” is a difference between blue code values of the pE pixel and pS pixel, “pE” is “pEncMove”, and “pS” is “pSrcMove”.

Next, a description will be given of a method for compressing an image by applying a dynamic link-size encoding method to the above-stated Lempel-Ziv compression method in accordance with an alternative embodiment of the present invention.

The principle concept of the Lempel-Ziv compression method is to transform repeated streams into linked data and append the transformed linked data to encoded data, as described above. Although the format of linked data may include various factors, it must include an offset of a source pixel and the number of identical pixels. Also, although “Link Identifier” has been used in the above description to represent the offset of the source pixel and the number of identical pixels, a 16-bit bitmap additionally requires a procedure of searching the entire image for an unused RGB code to define the “Link Identifier”. However, provided that all linked data are collectively expressed as one header, the “Link Identifier” is no longer required, instead there is a need for an offset of a pixel in which each link is to be inserted and processed. Further, the size of linked data must be expressed at the head of encoded data to make a distinction between the linked data and unlinked data. Therefore, the linked data format, above presented, can be changed and represented as follows.

The linked data format includes “Start Offset”, “Encode Offset” and “Matched Number”. The “Start Offset” is a value indicative of a number of one of streams of consecutive pixels, identical to a current link. The “Encode Offset” is a value indicative of a number of a pixel where a stream obtained from data of the current link is to be positioned. The “Matched Number” is a value indicative of the number of identical streams beginning with a current offset.

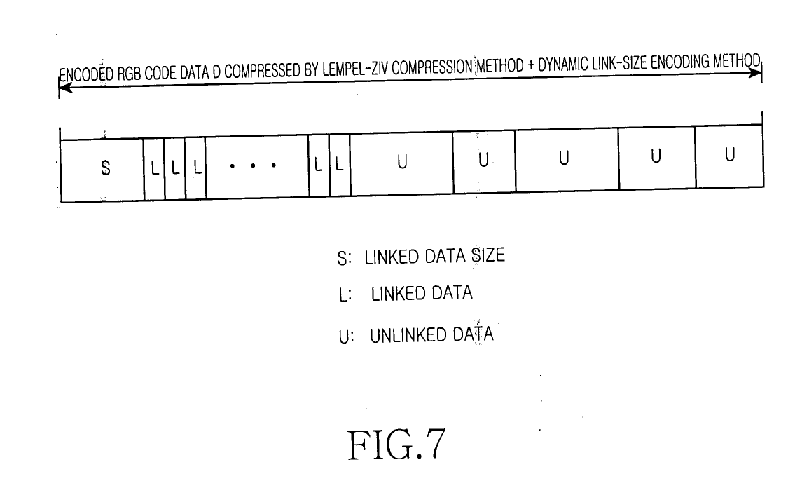

With the linked data format changed in the above manner, it is possible to change data generated according to the Lempel-Ziv compression method, as shown in FIG. 2, into encoded data as shown in FIG. 7. As a result, encoded data compressed according to the Lempel-Ziv compression method and dynamic link-size encoding method is expressed by linked data size information, linked data and unlinked data.

Even though encoded data is changed in the above manner, it has no particular difference in compression ratio as compared with the encoded data shown in FIG. 2. Assuming that the number of all pixels is less than 65,536 (16 bits), the size of one linked data is “Start Offset (2 bytes)”+“Encode Offset (2 bytes)”+“Matched Number (2 bytes)”, 6 bytes in total. However, each linked unit can be dynamically determined after the encoded data is changed as shown in FIG. 7.

Encoded data is extracted at steps S140 and S150 in FIG. 3 in the encoding procedure shown in FIGS. 3 and 4, wherein linked data is outputted at step S140 and unlinked data is outputted at step S150. The linked data to be outputted is composed at step S126 in FIG. 4. The linked data is first determined at step S126 and then outputted at step S140 in FIG. 3. At this time, the size of the linked data can be dynamically applied so that it can be different according to a given case.

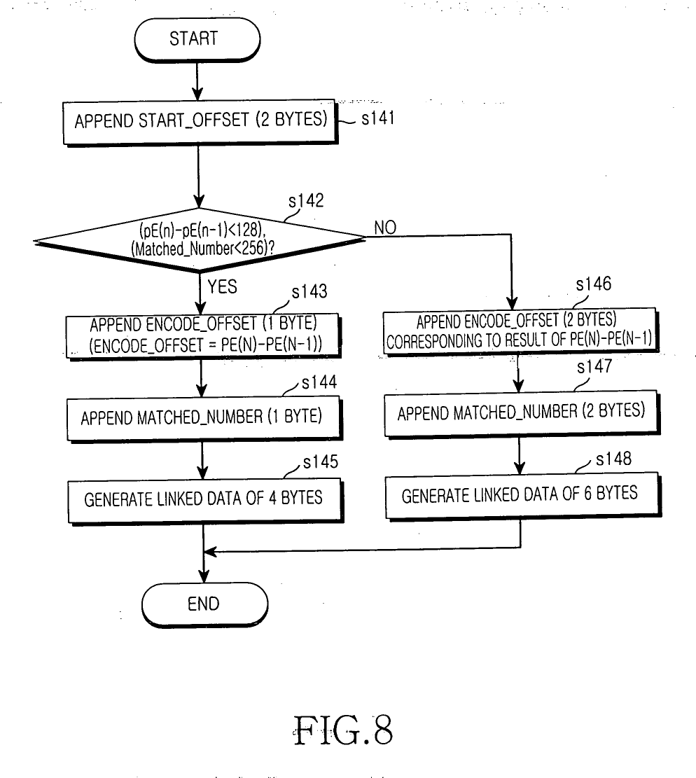

FIG. 8 is a flow chart illustrating a method for compressing an image by applying the dynamic link-size encoding method to the Lempel-Ziv compression method in accordance with an alternative embodiment of the present invention.

If duplicated patterns of the image are determined to exist at step S130 in FIG. 3, “Start_Offset (2 bytes)” representing a start position of a source pixel is appended (S141). A determination is made as to whether pE(n)-pE(n-1), which is a value of Encode_Offset(pE(n)) of a current link—Encode_Offset(pE(n-1)) of a previous link, is less than 128, and “Matched_Number” is less than 256 (S142).

If it is determined that the “pE(n)-pE(n-1)” is less than 128 and the “Matched_Number” is less than 256, then Encode_Offset (1 byte) corresponding to a result of the “pE(n)-pE(n-1)” is appended (S143). After the Encode_Offset (1 byte) is appended, Matched_Number (1 byte) is appended (S144). Accordingly, linked data of the total 4 bytes is generated by applying a dynamic link size to data compressed by the Lempel-Ziv compression method (S145). Namely, the format of the linked data of the total 4 bytes is composed of “Start_Offset” of 2 bytes, “pE(n)-pE(n-1)” of 1 byte and “Matched_Number” of 1 byte.

On the other hand, if it is determined that the “pE(n)-pE(n-1)” is not less than 128 or the “Matched_Number” is not less than 256, then Encode_Offset (2 bytes) corresponding to the result of the “pE(n)-pE(n-1)” is appended (S146). After the Encode_Offset (2 bytes) is appended, Matched_Number (2 bytes) is appended (S147). As a result, linked data of the total 6 bytes is generated by applying a dynamic link size to data compressed by the Lempel-Ziv compression method (S148). Namely, the format of the linked data of the total 6 bytes is composed of “Start_Offset” of 2 bytes, “pE(n)-pE(n-1)” of 2 bytes and “Matched_Number” of 2 bytes.

The reason why the dynamic link-size encoding method is applicable to the Lempel-Ziv compression method as shown in FIG. 8 is as follows. “Encode_Offset” must always be set to a value greater than that of a previous link, whereas “Start_Offset” is randomly set for each link. In the case where a difference between “Encode_Offset” of a current link and “Encode_Offset” of a previous link is outputted as a portion of the actual linked data instead of the “Encode_Offset” of the current link, the “Encode_Offset” of the current link can be expressed by a lesser value, 1 byte. Moreover, the “Matched Number” does not always exceed 256. When both these two conditions are satisfied, the 4-byte linked data size encoding can be applied to the Lempel-Ziv compression method, thereby making it possible to implement the image compression based on the dynamic link-size encoding method.

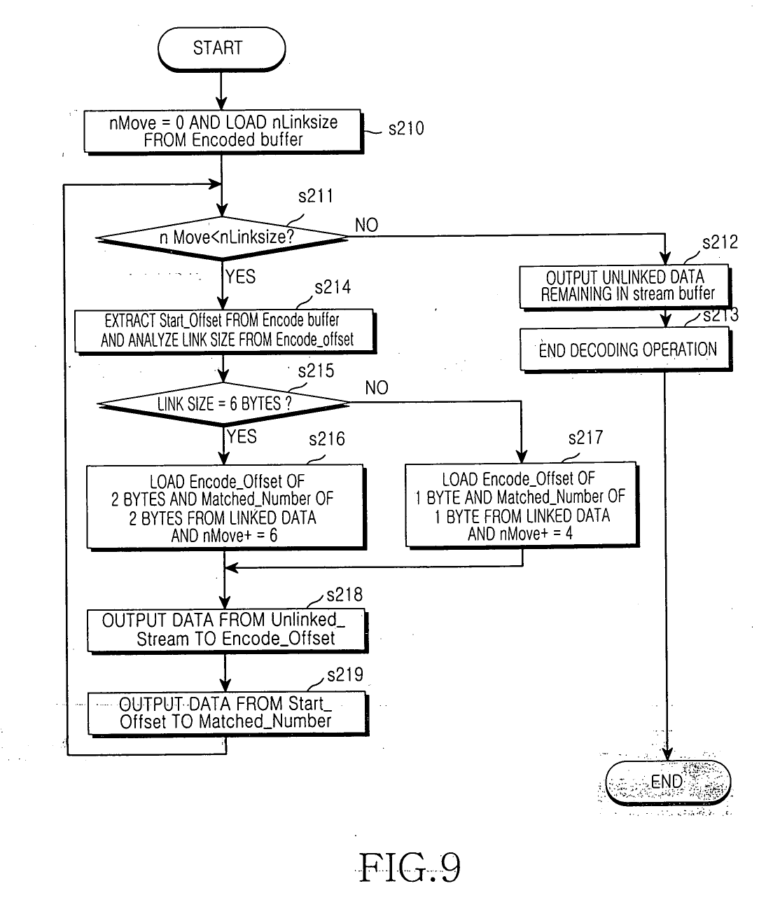

FIG. 9 is a flow chart illustrating a procedure of decoding encoded data compressed according to the image compression method of FIG. 8. First, “nMove”, which is a moving offset of linked data, is initialized to 0, and “nLinkSize”, which is the entire link size of encoded data, is loaded from “Encoded buffer”, which stores the encoded data (S210). Note that the first 2 bytes of the encoded data represent the entire size of a linked data list. In this regard, the “nLinkSize” which is the entire link size of the encoded data is loaded from the “Encoded buffer”. If the “nMove” which is the moving offset of the linked-data-is initialized to 0 and the “nLinkSize” which is the entire link size of the encoded data is loaded, then a determination is made as to whether the “nMove” is less than the “nLinkSize” (S211).

If the “nMove” is determined not to be less than the “nLinkSize”, then unlinked data remaining in a stream buffer is outputted because this determination signifies that the decoding of all the linked data has been completed (S212). As a result, the decoding operation for the compressed image is ended (S213).

On the other hand, in the case where the “nMove” is determined to be less than the “nLinkSize”, Start_Offset of a linked data format is extracted from “Encoded buffer (2 bytes)”, and an analysis is made on the basis of the first bit of Encode_Offset as to whether a link size is 4 bytes or 6 bytes (S214). A determination is made from the analysis result as to whether the link size is 6 bytes (S215). If the link size is determined to be 6 bytes, then “Encode_Offset” of 2 bytes and “Matched_Number” of 2 bytes are loaded from the linked data (S216). Also, the “nMove” which is the moving offset of the linked data is incremented by 6.

In the case where the link size is determined not to be 6 bytes at step S215, the link size is determined to be 4 bytes, and “Encode_Offset” of 1 byte and “Matched_Number” of 1 byte are loaded from the linked data (S217). Further, the “nMove” which is the moving offset of the linked data is incremented by 4.

After step S216 or S217 is performed, data from Unlinked_stream to “Encode_Offset” of the linked data is outputted from an unlinked data buffer to “Decoding buffer”, which stores decoded data (S218). Streams from “Start_Offset” to “Matched_number” are copied and outputted from the linked data to the “Decoding buffer” (S219). As a result, the encoded linked data is decoded using the streams from the “Start_Offset” to “Matched_number”. If all the remaining unlinked data is outputted as at step S212 after all the linked data is decoded, then the decoding operation for the compressed image is ended.

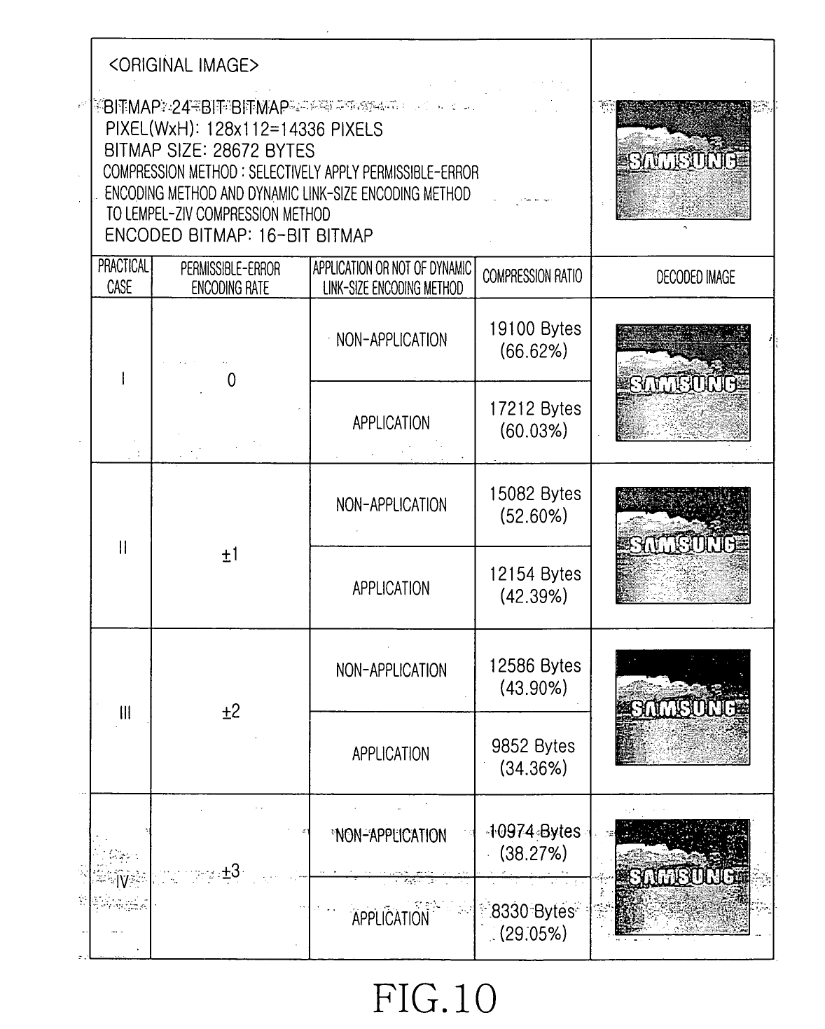

FIG. 10 shows compression ratios of images compressed according to the first and second embodiments of the present invention. Although the Lempel-Ziv compression method may show different results according to RGB code values of images because it is based on a statistical encoding method, FIG. 10 illustrates how much better the compression effect becomes when the permissible-error encoding method and dynamic link-size encoding method are applied to the Lempel-Ziv compression method.

In the following example, the entire image pixel size is 14,336 (=128×112) pixels, and 16-bit bitmap data per one pixel was encoded. Because the 16-bit bitmap data has a size of 2 bytes per one pixel, the entire size of the original image is 28,672 bytes. All encoding methods employed the Lempel-Ziv compression method, and the error rate was incremented one by one to show the permissible-error encoding effect. In order to show the dynamic link-size encoding effect, a compression size based on the application or not of the dynamic link-size encoding method was indicated, compared and analyzed for each permissible-error encoding case. The degrees of damage on respective decoded images were different depending on the permissible-error encoding method irrespective of the dynamic link-size encoding method. The sizes of actually displayed images were magnified by 1.5 times in order to show the damage degrees of the respective images.

For each practical case, the permissible-error encoding rate is an encoding condition for admitting an RGB code value to be the same as an RGB code value of the original image even though it has a difference of ±n with the RGB code value of the original image when being compared therewith. The sizes of encoded data were compared between the application and non-application of the dynamic link-size encoding method. As seen from the comparison results, the respective encoded and decoded images are subject to a larger amount of damage as the permissible-error encoding rate increases, but their damage differences are so very fine that they can be viewed only when being enlarged. Furthermore, in the case where the permissible-error encoding rate is on the order of ±1, the respective decoded images have such little differences with the original-image that their-losses are difficult to perceive. However, the higher the permissible-error encoding rate, the better the compression ratio. As a result, when the permissible-error encoding rate is on the order of ±3, the compression ratio is reduced to 38%. Moreover, it can be seen that the compression ratio is reduced to 29% at maximum when the dynamic link-size encoding method is applied.

As apparent from the above description, according to the present invention, a permissible-error (PE) encoding method and a dynamic link-size encoding method are selectively applied to a Lempel-Ziv compression method, which is a zero loss compression method, to compress an image. Therefore, an image compression efficiency can be raised.

Further, the permissible-error encoding-compression method is applied to a target image to encode it into code values with small differences. This can obtain an excellent compression effect over the existing image compression based on only the Lempel-Ziv compression method.

Furthermore, the dynamic link-size encoding method is additionally applied to an image encoded according to the Lempel-Ziv compression method and, in turn, the permissible-error encoding method. This has the effect of compressing the image three times, so as to obtain a higher compression efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image compression method for increasing a data rate and decoding performance of an image to be transmitted, comprising the steps of:
a) determining whether respective codes corresponding to said image are repeated, encoding repeated codes of the corresponding codes into linked data indicative of a start position and number of the repeated codes, and encoding non-repeated codes of said corresponding codes into unlinked data indicative of the non-repeated codes; and
b) setting a linked data size indicative of an entire size of said linked data, consecutively arranging said linked data, arranging said linked data size upstream of said consecutively arranged linked data and arranging said unlinked data downstream of said consecutively arranged linked data.

2. An image compression method for increasing a data rate and decoding performance of an image to be transmitted, comprising the steps of:
a) determining whether respective codes corresponding to said image are repeated, encoding repeated codes of the corresponding codes into linked data indicative of a start position and number of the repeated codes, and encoding non-repeated codes of said corresponding codes into unlinked data indicative of the non-repeated codes; and
b) setting a permissible error with respect to each of said linked data and encoding said linked data within the range of the set permissible error.

3. The image compression method as set forth in claim 2, wherein said permissible error is variably set and said image is increased in its compression efficiency as said range of said permissible error increases.

4. An image compression method for increasing a data rate and decoding performance of an image to be transmitted, comprising the steps of:
a) initializing a position of a current pixel of said image to be encoded and a position of a previous pixel to be compared with said current pixel to find repeated patterns with respect to said current pixel;
b) comparing said current pixel position with said previous pixel position to determine whether said current pixel position is less than said previous pixel position;
c) obtaining differences between code values from said current pixel position to a certain pixel position and code values from said previous pixel position to just before said current pixel position if said current pixel position is determined to be less than said previous pixel position;
d) selecting one of said differences existing within the range of a set permissible error as a permissible value and determining whether said permissible value is repeated; and
e) if said permissible value is determined to be repeated, transforming the repeated permissible values into linked data including a start position and number of the repeated permissible values, and, if said permissible value is determined not to be repeated, maintaining the permissible value.

5. The image compression method as set forth in claim 4, wherein said permissible error is variably set and said image is increased in its compression efficiency as said range of said permissible error increases.

6. An image compression method for increasing a data rate and decoding performance of an image to be transmitted, comprising the steps of:
a) initializing a position of a current pixel of said image to be encoded and a position of a previous pixel to be compared with said current pixel to find repeated patterns with respect to said current pixel;
b) comparing said current pixel position with said previous pixel position to determine whether said current pixel position is less than said previous pixel position;
c) determining whether code values from said current pixel position to a certain pixel position and code values from said previous pixel position to just before said current pixel position are repeated, if said current pixel position is determined to be less than said previous pixel position;
d) transforming repeated codes of said code values into linked data including a start position and number of the repeated code values, and maintaining non-repeated codes of said code values as unlinked data;
e) setting information regarding an entire size of said linked data, consecutively arranging said linked data and arranging said entire size information of said linked data upstream of said consecutively arranged linked data; and
f) arranging said unlinked-data downstream of said consecutively arranged linked data.

7. The image compression method as set forth in claim 6, wherein said entire size of said linked data is any one of 4 bytes and 6 bytes.

8. An image compression method for increasing a data rate and decoding performance of an image to be transmitted, comprising the steps of:
a) initializing a position of a current pixel of said image to be encoded and a position of a previous pixel to be compared with said current pixel to find repeated patterns with respect to said current pixel;
b) comparing said current pixel position with said previous pixel position to determine whether said current pixel position is less than said previous pixel position;
c) obtaining differences between code values from said current pixel position to a certain pixel position and code values from said previous pixel position to just before said current pixel position if said current pixel position is determined to be less than said previous pixel position;
d) selecting one of said differences existing within the range of a set permissible error as a permissible value and determining whether said permissible value is repeated;
e) if said permissible value is determined to be repeated, transforming the repeated permissible values into linked data including a start position and number of the repeated permissible values, and, if said permissible value is determined not to be repeated, maintaining the permissible value; and
f) setting information regarding an entire size of said linked data, consecutively arranging said linked data, arranging said entire size information of said linked data upstream of said consecutively arranged linked data and arranging unlinked data downstream of said consecutively arranged linked data.

9. The image compression method as set forth in claim 8, wherein step e) includes the step of performing a permissible-error encoding operation, and step f) includes the step of performing a dynamic link-size encoding operation.

10. The image compression method as set forth in claim 9, wherein said permissible error is variably set and said image is increased in its compression efficiency as said range of said permissible error increases.

11. The image compression method as set forth in claim 10, wherein said entire size of said linked data is one of 4 bytes and 6 bytes.
